(19) United States
(12) Patent Application Publication
(10) Pub. No.: US 2004/0201978 A1
(43) Pub. Date: Oct. 14, 2004

(54) Light source structure

(76) Inventor: Heng Sheng Kuo, Taipei (TW)

Correspondence Address: HENG SHENG KUO, P.O. BOX 26-757, TAIPEI, 106, TW

(21) Appl. No.: 10/759,951

(22) Filed: Jan. 16, 2004

(30) Foreign Application Priority Data
Apr. 11, 2003 (TW) 92205738

(51) Int. Cl. F21V 7/04

(52) U.S. Cl. 362/31

(57) ABSTRACT

A light source structure has a guidelight plate, a lighting unit with a lighting member and a plurality of lighting components respectively disposed on sides of the guidelight plate. According to particular locations of the lighting member and the lighting components, the light source structure is thin, small, and cheap, with the added benefits of a high luminance and a high uniformity thereof.

### BACKGROUND OF THE INVENTION

1. Field of the Invention

The present invention relates to a light source structure, and particularly relates to a light source structure adopted for documents, negative films, or positive films scanned.

2. Background of the Invention

With reference to FIGS. 1 and 2, a guidelight plate 9 and a lighting unit 8 include a lamp 80 and a plurality of lighting components 81. The lighting components 81 include a circuit board 82, and a plurality of LEDs and resistors disposed on the circuit board 82. The guidelight plate 9 is a flat, rectangular, and transparent plate with a recess 90 formed in a side thereof and shaped like a square for receiving the lamp 80 therein. The lighting component 81 is installed on an elongated side 91 of the guidelight plate 9. The elongated side 91 is adjacent to the recess 90, and thus the lighting components 81 and the lamp 80 together are disposed on the same side of the guidelight plate 9.

Connections between the lighting unit 8 and the guidelight plate 9 include disposing the lighting components 81 and the lamp 80 on the same side wall of the guidelight plate 9 and arranging the lighting components 81 higher than the lamp 80 when assembling the same onto the guidelight plate 9. That, however, leads light emitted from the lighting components 81 and the lamp 80 through different transmission passages with different thicknesses. The light of the lamp 80 passes around a corner adjacent to the recess 90 and is interfered with thereby to decrease luminance and uniformity of the guidelight plate 9. Furthermore, connections between lighting unit 8 and the guidelight plate 9 needs a thick thickness incurring higher costs.

Hence, an improvement over the prior art is required to overcome the disadvantages thereof.

### SUMMARY OF INVENTION

The primary object of the invention is therefore to specify a light source structure with a reduced thickness thereof due to a lighting unit with a particular location, so that volume thereof shrinks and costs accordingly diminish.

The secondary object of the invention is therefore to specify a light source structure with a high luminance and a high uniformity thereof.

According to the invention, this object is achieved by a light source structure including a guidelight plate and a lighting unit including a lighting member and a plurality of lighting components respectively disposed on sides of the guidelight plate.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a decomposition view according to a conventional light source structure;

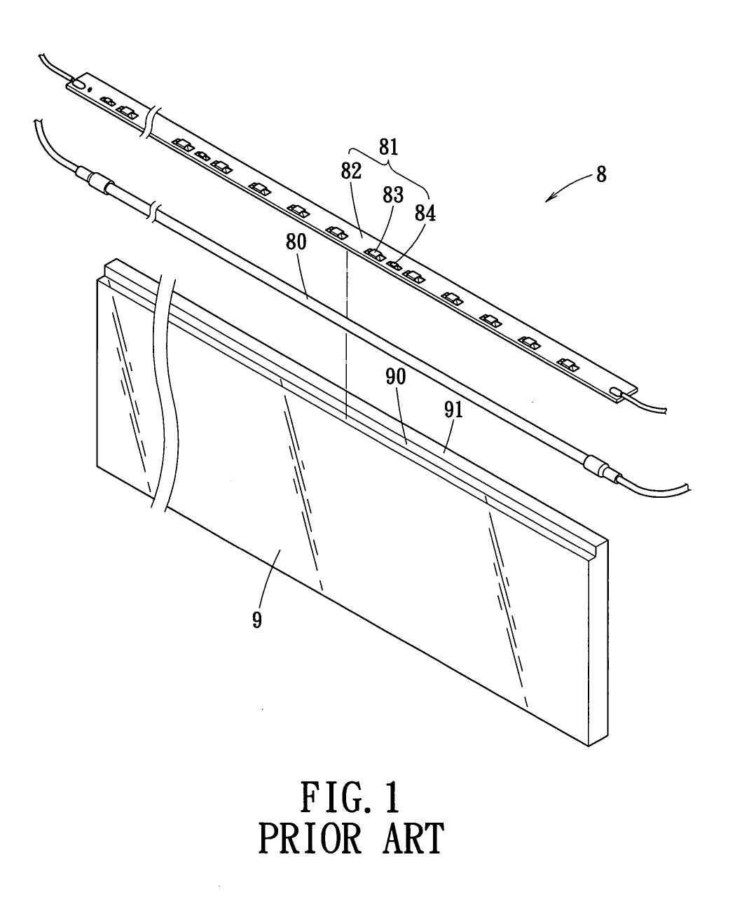

FIG. 2 is a cross-sectional profile according to the conventional light source structure;

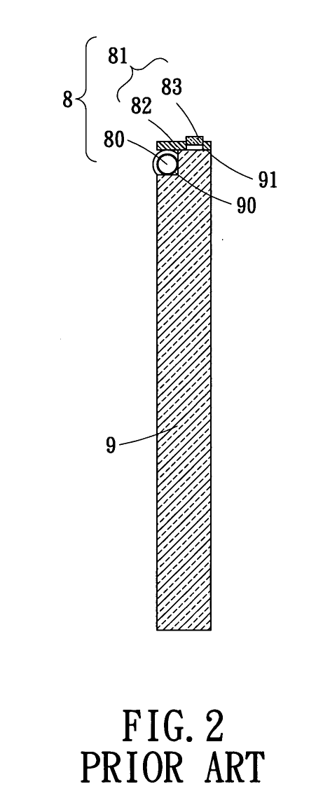

FIG. 3 is a decomposition view of a light source structure according to the present invention;

FIG. 4 is a perspective view of the light source structure according to the present invention;

FIG. 5 is a cross-sectional profile of the light source structure according to the present invention; and

FIG. 6 is a perspective view of the light source structure according to another embodiment of the present invention.

### DETAILED DESCRIPTION OF THE EMBODIMENTS

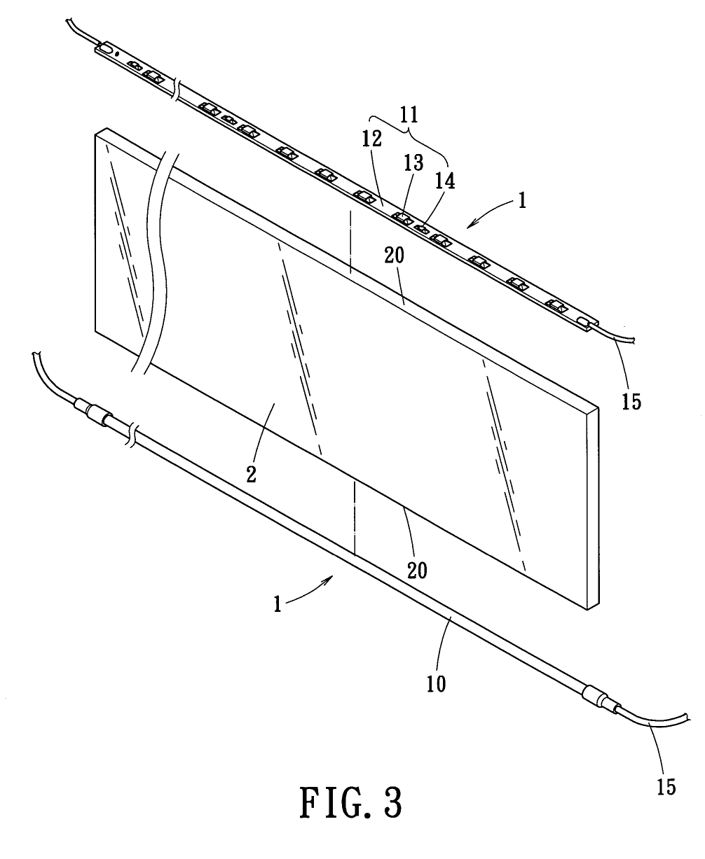

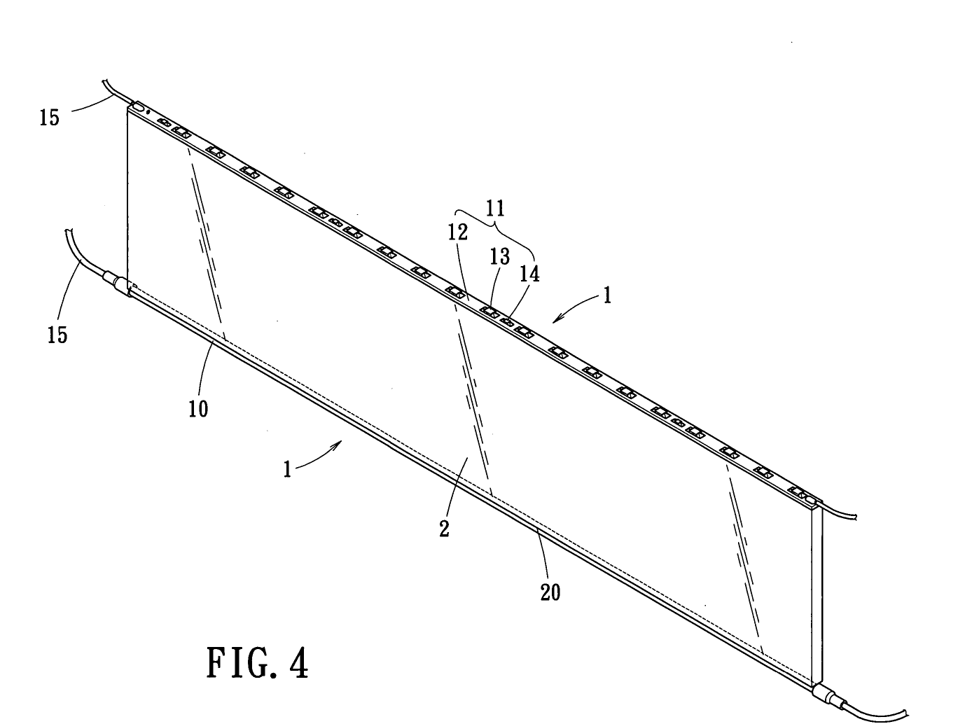

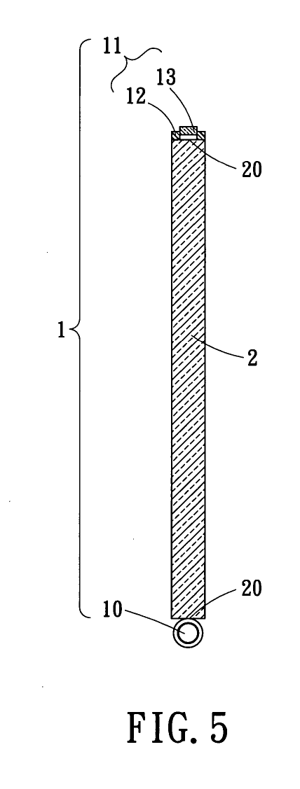

Referring to FIGS. 3 to 5, the present invention provides a light source structure including a lighting unit 1 and a guidelight plate 2. The lighting unit 1 includes a lighting member 10 and a plurality of lighting components 11. The lighting member 10 is a CCFL (Cold Cathode Florescent Lamp). The lighting components 11 include a circuit board 12 and a plurality of LEDs (Light Emitting Diode) and resistors 14. The lighting member 10 and the lighting components 11 respectively connect power cores 15 for providing power. The guidelight plate 2 is a flat, rectangular, and transparent plate, and has two elongated sides 20 opposite each other. The lighting member 10 and the lighting components 11 are respectively disposed on the two elongated sides 20. Thus, the present invention light source structure is assembled.

When the light source structure is in use, lights emitted from the lighting member 10 and the lighting components 11 is transmitted through the sides 20 uniformly. The sides 20 have the same thickness; accordingly, a luminance and a uniformity of the guidelight plate 2 can be improved.

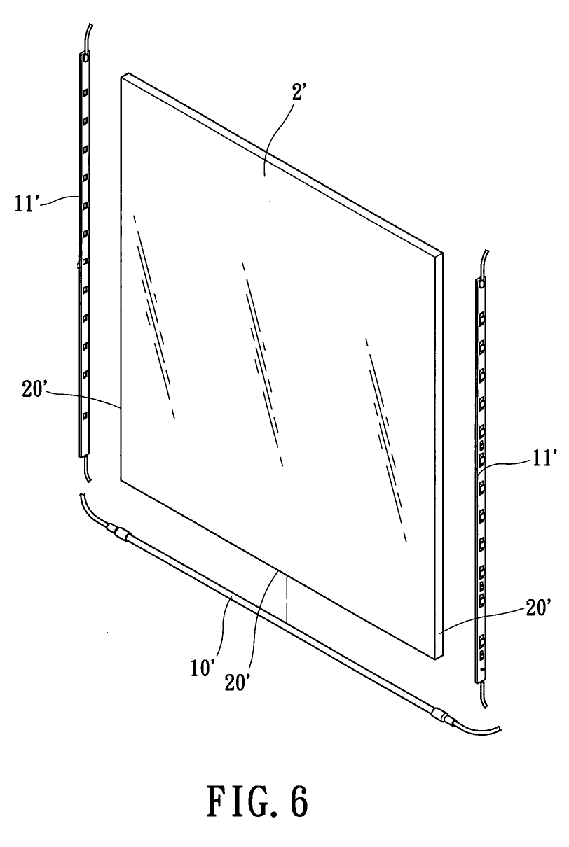

With respect to FIG. 6, another embodiment of the present invention, the lighting member 10 disposes on a side 20′ of the guidelight plate 2′, and the lighting components 11 are disposed respectively on two lateral sides 20′ of the guidelight plate 2. The two lateral sides 20′ are perpendicular to the side 20.

According to the present invention, the lighting member 10 (10′) and the lighting components 11 (11′) are respectively disposed on sides of the guidelight plate 2 (2′). The light source structure needs no additional recess formed in the guidelight plate 2 for receiving the lighting member; thus the guidelight plate 2 has a reduced thickness to shrink a volume thereof and to cut off costs thereby. Furthermore, light emitted by the lighting member 10 (10′) and the lighting components 11 (11′) can be transmitted thought the guidelight 2 with uniform thickness; thus the luminance and the uniformity of the guidelight plate 2 can be increased.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A light source structure, comprising:
a guidelight plate; and
a lighting unit including a lighting member and a plurality of lighting components respectively disposed on sides of the guidelight plate.

2. The light source structure as claimed in claim 1, wherein the lighting member is a CCFL.

3. The light source structure as claimed in claim 1, wherein the lighting components include a circuit board and a plurality of LEDs and resistors disposed thereon.

4. The light source structure as claimed in claim 1, wherein the guidelight plate is a flat, rectangular, and transparent plate.

5. The light source structure as claimed in claim 1, wherein the guidelight plate has two elongated sides opposite each other, and the lighting member and the lighting components are respectively disposed on the two elongated sides.

6. The light source structure as claimed in claim 1, wherein the lighting member is disposed on a side of the guidelight plate, and the lighting components are disposed respectively on two lateral sides of the guidelight plate, wherein the two lateral sides are perpendicular to the side.
